(19) United States
(12) Patent Application Publication
(10) Pub. No.: US 2007/0104617 A1
(43) Pub. Date: May 10, 2007

(54) Capped tubes

(75) Inventors: Jeffrey Leonard Coulling, Kent (GB); Clive Ian Harrison, Kent (GB)

Correspondence Address: WOOD, HERRON & EVANS, LLP, 2700 CAREW TOWER, 441 VINE STREET, CINCINNATI, OH, 45202, US

(73) Assignee: Advanced Biotechnologies Limited

(21) Appl. No.: 11/267,202

(22) Filed: Nov. 4, 2005

(51) Int. Cl. B01L 3/00

(52) U.S. Cl. 422/102

(57) ABSTRACT

In a first aspect the present invention provides a screw-capped tube for holding a liquid material therein, the tube having an open mouth at one end only which is adapted to be closed by the screw cap with an inner end of the screw cap extending into the open mouth of the tube, an opposing end of the cap to the inner end of the cap being provided with a circular cylindrical recess extending thereinto and whereof the cylindrical wall of the recess is free of splines, an outer circumferential surface of the cap being provided with a spline whereby the cap is adapted to co-operatively engage with a spline of a tool that will fit on to said opposite end of the cap for rotation of the cap by co-operative engagement of the spline of the tool with the spline of the cap. This arrangement increases versatility and ease in de-capping and re-capping of the tubes. Further aspects also assist with this and/or improve seal efficiency and help to avoid the need for O ring sealing for cryogenic uses and other uses.

### FIELD OF THE INVENTION

The present invention concerns capped tubes such as are used in laboratories for holding liquid reagents or samples and is particularly applicable to screw-capped tubes, suitably cluster tubes, and especially suitably cryogenic tubes.

### BACKGROUND TO THE INVENTION

In the modern life sciences laboratory one of the basic items of apparatus that has evolved markedly in recent years is the sample or reagent storage vessel. To cater for small sample or reagent volumes and facilitate high throughput, common characteristics of modern reagent/sample vessels are that they are generally moulded of plastics, very small, e.g. 0.5 ml capacity, and in the case of cluster tubes are adapted to be configured in high density arrangements of, for example, 48 or 96 tubes configured in a matrix array and rack mounted. Commonly, the tubes are of polypropylene and for those tubes that are provided with caps, both the tube and the cap are generally of polypropylene.

One popular form of reagent/sample tube is the screw capped cluster tube wherein the tube has at its mouth a screw thread to engage with a complementary screw thread of a plug portion on the underside of the screw cap. For many uses screw cap cluster tubes perform satisfactorily. However, where tubes of this type are to be used in extreme temperature environments and, in particular, in extreme low temperature environments such as for cryogenic storage in the gas phase of a liquid nitrogen cooled vessel, generally at or above −196° C., a characteristic of the construction of the tube and cap can cause substantial problems in maintaining the seal integrity of the cap to the tube. The material most commonly used in construction of the tubes, polypropylene, has a comparatively high coefficient of thermal expansion and will contract quite substantially when subjected to a reduction in environmental temperature from around room temperature to −196° C. Contraction of the polypropylene material forming the mating threads of the screw-capped tube compromises the integrity of the screw engagement and undermines the sealing effectiveness of the cap. Accordingly, for cryogenic environments screw cap cluster tubes are generally provided with supplemental O-ring seals as an interface between the cap and tube to maintain seal integrity in the cryogenic environment.

The present invention seeks, amongst other objectives, to avoid the need to rely on O-ring seals in the construction of screw-capped cluster tubes whilst nevertheless enabling them to be used in extreme low temperature environments without substantially compromising the integrity of the screw cap closure and sealing effectiveness.

A further problem area with screw capped tubes is the amount of handling time required to de-cap and re-cap them in use. For high throughput programmes and programmes where multiple de-capping and re-capping steps are necessitated—e.g. where samples need to be taken from the tube at intervals or reagents/media added at intervals—the time taken to remove the cap and replace it can be a significant impediment to the efficiency of the programme. For smaller screw capped cluster tubes, such as those that are generally of the order of 0.5 or 1 ml in capacity, the size of the screw cap is relatively small and the tubes generally densely arrayed (eg in a 96 tube cluster tube rack in a grid arrangement occupying a footprint of less than 12 cm by 8 cm), making access to individual caps awkward and giving handlers difficulty in de-capping and re-capping them in the racks.

It is a further general objective of the present invention to provide means whereby a handler may readily de-cap and re-cap a screw capped tube straight forwardly and efficiently. The present invention thus provides inter alia a modified screw cap for a screw capped tube, a tool for de-capping and re-capping, a tube optimised for de-capping and/or re-capping in a rack and a rack suitable for the purpose.

### SUMMARY OF THE INVENTION

According to a first aspect of the present invention, there is provided a screw-capped tube for holding a liquid material therein, the tube having an open mouth at one end only which is adapted to be closed by the screw cap with an inner end of the screw cap extending into the open mouth of the tube, an opposing end of the cap to the inner end of the cap being provided with a circular cylindrical recess extending thereinto whereof the circumferential wall of the recess is free of splines, an outer circumferential surface of the cap being provided with a spline whereby the cap is adapted to co-operatively engage with a spline of a tool that will fit on to said opposite end of the cap for rotation of the cap by co-operative engagement of the spline of the tool with the spline of the cap. Suitably each of the cap and tool head have multiple splines.

Preferably the screw capped tube is provided in combination with a said tool and whereof the tool has a head formed with a socket to mount over said opposing end of the cap and said at least one spline is formed in the socket of the head of the tool extending radially inwardly. Suitably the socket of the head of the tool further comprises a centring spigot located substantially centrally of the socket and which is adapted to extend into the recess of the cap. Preferably the tool is a hand held tool having a handle extending from the head.

Particularly preferably the tool head has a lifting co-operative engagement feature thereon to co-operatively engage with a complementary co-operative engagement feature on the cap whereby the cap may be held on the tool to be liftable by the tool when the tool head and cap are rotated in a first direction and which disengage, releasing the cap from the tool, when the tool is rotated in the opposing direction. This feature provides the considerable advantage of allowing an operator to execute a full de-capping and re-capping procedure entirely single handedly, avoiding the operator having to hold the tubes down at any stage and especially not at the end of capping/re-capping. The cap is not frictionally held on the tool for lifting and the tool will release its hold on the cap straightaway as/when the cap is re-threaded on to the tube by the tool.

In a preferred embodiment the lifting co-operative engagement feature of one of the cap and tool head is a prominence adjacent a spline of the cap or tool head and the other co-operative engagement feature is a recess in a spline of the other of the cap and tool head. Thus, for example, the splines of the cap are provided with recesses that co-operatively engage with one or more prominences, eg bulges or lugs, adjacent one or more of the splines of the cap.

Thus, in accordance with a second aspect of the present invention there is provided a screw-capped tube for holding a liquid material therein, the tube having an open mouth at one end only which is adapted to be closed by the screw cap with an inner end of the screw cap extending into the open mouth of the tube, the cap being provided with at least one spline whereby the cap is adapted to co-operatively engage with a spline of a tool that will fit on to said cap for rotation of the cap by co-operative engagement of the spline of the tool with the spline of the cap the tool head having a lifting co-operative engagement feature thereon to co-operatively engage with a complementary co-operative engagement feature on the cap whereby the cap may be held on the tool to be liftable with the tool when the tool head and cap are rotated in a first direction and which disengage, releasing the cap from the tool, when the tool is rotated in the opposing direction.

For single handed de-capping and re-capping of screw capped tubes, the system of the present invention makes use of racks for the tubes wherein each well/receptacle in the rack to receive each tube has at least one spline to co-operatively engage with a complementary spline on the outer circumference of the tube. Particularly preferably the tube has a number of splines thereon for engagement with the splines of a receptacle of the rack, which is greater than the number of splines of the receptacle of the rack. For example, whereas the optimal number of splines per receptacle of the rack is four, one at each of four “corners” of each receptacle (the tubular receptacles being arranged together in a rectangular grid formation) the external circumference of the tube suitably has more than four splines and preferably at least six splines and suitably eight or more splines. This relatively high number of splines on the tube optimises the rotational alignment of the tube splines with the rack splines.

Particularly preferably the splines of the rack are provided at or adjacent the upper surface/platform of the rack. Preferably the splines of the rack comprise a cruciform formation that protrudes from the upper surface of the rack.

One of the several advantages of positioning the splines of the rack high up on the rack structure is that the number of splines around the circumference may be maximised in a tube where the outer circumference of the tube reduces down the length of the tube, whether the tube is smoothly tapered or instepped down its length/height. Accordingly, it is preferred that the splines are at a height position on the tube above where there is any substantial inward tapering or instep of the outside diameter of the tube.

In refinements of the rack, it is preferred that the rack be provided with means for identifying the orientation of the rack from the underside of the rack to facilitate reading of identification codes on the bottom of tubes held in the rack by viewing the rack from the underside. To this end, where the underside of the rack is otherwise substantially symmetrical, the rack suitably has a cut-out feature incorporated into the underside thereof and visible from the underside and which is asymmetrically positioned on the underside of the rack for the orientation of the rack to be determined.

Preferably the screw cap has a plug portion that is adapted to extend into the bore of the tube and which has screw thread formations to engage with corresponding co-operatively engaging screw thread formations in the bore of the tube, the screw threaded part of the cap being formed of material having a different coefficient of thermal expansion than the corresponding co-operatively engaging screw threaded part of the tube. The coefficient of thermal expansion of the mating/screw threaded part of the cap may be lower for some embodiments (generally maximising radial interference between the cap and the wall of the tube), but may be higher for others (generally maximising axial interference between screw threads by pulling of the cap outwardly relative to the tube).

Preferably the plug portion has a curved or frusto-conical tapering surface that seats against a complementary surface/shoulder at the mouth end of the tube to form a sealing interface between the cap and the tube at or above the top of the threads.

Suitably below the cap's screw thread formation the plug portion of the cap extends for a distal length which forms a tight interference fit with the bore of the tube in use and provides a parallel pressure seal between the cap and the tube.

Suitably the tube as a whole is formed of one material and the cap plug portion is formed of a different material, of different thermal expansion coefficient.

In a particularly preferred embodiment the tube is formed of polypropylene and the cap bung portion or entirety of the cap is formed of an elastomeric material, suitably a thermoset elastomer or a thermoplastic elastomer such as, for example, Santoprene™.

Preferably the cap portion that co-operatively engages with the tube has a part that forms an interference fit in the bore of the tube, whereby the interference at the interference fit portion will increase when the capped tube is refrigerated.

Particularly preferably the capped tube has no O-ring seal components provided therein to seal between the cap and the tube.

According to a further aspect of the present invention there is provided a screw-capped tube for holding a liquid material therein, the tube having an open mouth at one end only and which is adapted to be closed by the screw cap, wherein at least a part of the cap that engages with the tube is formed of a material that is different from the co-operative engaging part of the tube whereby when the capped tube is subjected to a significantly colder thermal environment the tightness of fit between the cap and the tube is maintained and preferably will increase.

According to a yet further aspect of the present invention there is provided a screw-capped tube for holding a liquid material therein, the tube having an open mouth at one end only and which is adapted to be closed by the screw cap, the screw cap having a plug portion that is adapted to extend into the bore of the tube and which has screw thread formations to engage with corresponding co-operatively engaging screw thread formations in the bore of the tube, the plug portion having a curved or frusto-conical tapering surface that seats against a complementary surface/shoulder at the mouth end of the tube to form a sealing interface between the cap and the tube at or above the top of the threads. Preferably the capped tube has no O-ring seal components provided therein to seal between the cap and the tube.

According to a yet further aspect of the present invention there is provided a screw-capped tube for holding a liquid material therein, the tube having an open mouth at one end only and which is adapted to be closed by the screw cap, the screw cap having a plug portion that is adapted to extend into the bore of the tube and which has screw thread formations to engage with corresponding co-operatively engaging screw thread formations in the bore of the tube, wherein below the cap's screw thread formation the plug portion of the cap extends for a distal length which forms a tight interference fit with the bore of the tube in use and provides a parallel pressure seal between the cap and the tube. Suitably this aspect is combined with the preceding aspect. Again preferably the capped tube has no O-ring seal components provided therein to seal between the cap and the tube.

Particularly preferably in either of these latter aspects the part of the cap that co-operatively engages with the tube has a different coefficient of thermal expansion from the co-operative engaging part of the tube.

### BRIEF DESCRIPTION OF THE DRAWINGS

Preferred embodiments of the present invention will now be more particularly described, by way of example, with reference to the accompanying drawings, wherein:

FIG. 1 is a side elevation view of a tube, e.g. a 0.5 ml cluster tube, adapted to be capped by a screw cap;

FIG. 2 is a top plan view of the open tube;

FIG. 3 is a bottom plan view of the tube;

FIG. 4 is a longitudinal sectional view of the tube taken along the line 4-4 in FIG. 3;

FIG. 5 is a side elevation view of a screw cap for the tube of FIG. 1;

FIG. 6 is a side elevation view of the screw cap turned through approximately 90 degrees;

FIG. 7 is a longitudinal sectional view through the screw cap taken along the line 7-7 in FIG. 8;

FIG. 8 is a top plan view of the screw cap;

FIG. 9 is a bottom plan view of the screw cap;

FIG. 10 is a transverse sectional view of the screw cap taken along the line 10-10 in FIG. 5;

FIG. 11 is a detailed view of the mounting of the cap plugging the mouth of the tube in use;

FIG. 12 is a side elevation view of a hand-held tool for removal of the cap from the tube;

FIG. 13 is a sectional view taken along the line 13-13 in FIG. 15;

FIG. 14 is a rear end elevation view of the tool;

FIG. 15 is a front end elevation view of the tool;

FIG. 16 is a top plan view of a cluster tube rack to receive the tubes of FIGS. 1 to 4 in an 8×12 array;

FIG. 17 is a bottom plan view of the rack;

FIG. 18 is a sectional view taken along the line 18-18 in FIG. 16;

FIG. 19 is a sectional view taken along the line 19-19 in FIG. 16;

FIG. 20 is a front elevation view of a 1 ml embodiment of the cluster tube (the lower end of the tube may have a label chamber mounted to the bottom of the tube);

FIG. 21 is a longitudinal sectional view of the tube taken along the line 21-21 in FIG. 23;

FIG. 22 is a top plan view of the tube;

FIG. 23 is a bottom plan view of the tube;

FIG. 24 is a top plan view of a cluster tube rack for the 1 ml cluster tube;

FIG. 25 is a bottom plan view of the cluster tube rack; and

FIG. 26 is a sectional view taken along the line 26-26 in FIG. 24 and further showing three cluster tubes in place in the rack and with a lid mounted to the rack.

### DESCRIPTION OF THE PREFERRED EMBODIMENT

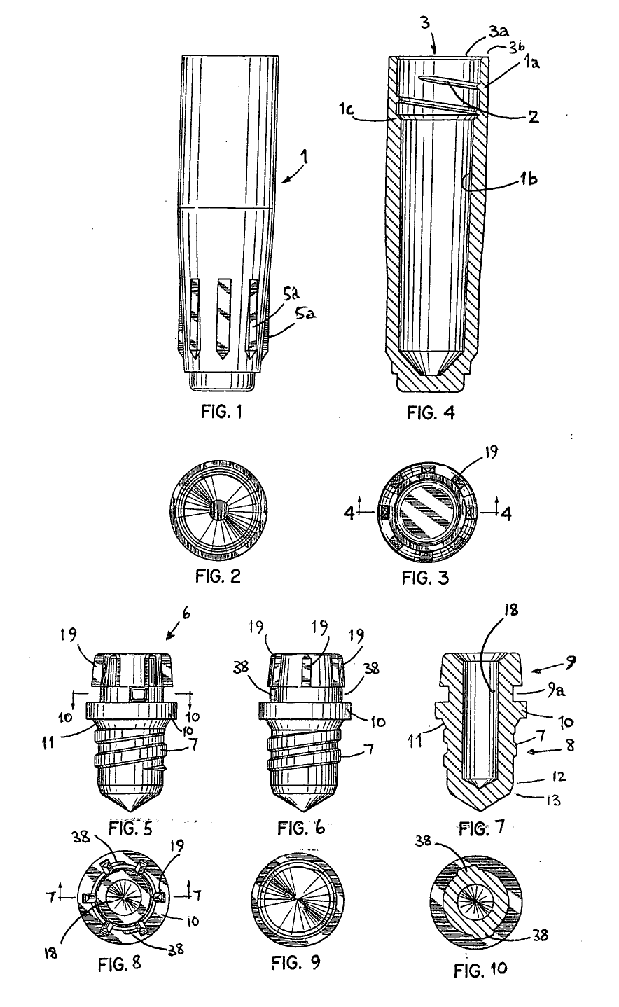

Referring to the Figures, the tube 1 shown in FIGS. 1 to 4 is moulded of polypropylene and having a screw thread formation 2 moulded at its upper end/mouth end 3. The rim of the opening of the tube 1 at the mouth end 3 has an upper end surface 3b and is recessed/part cutaway immediately around the opening to define a frusto-conical surface 3a at the entrance to the bore of the tube 1 against which an upper end of the cap 6 may seat.

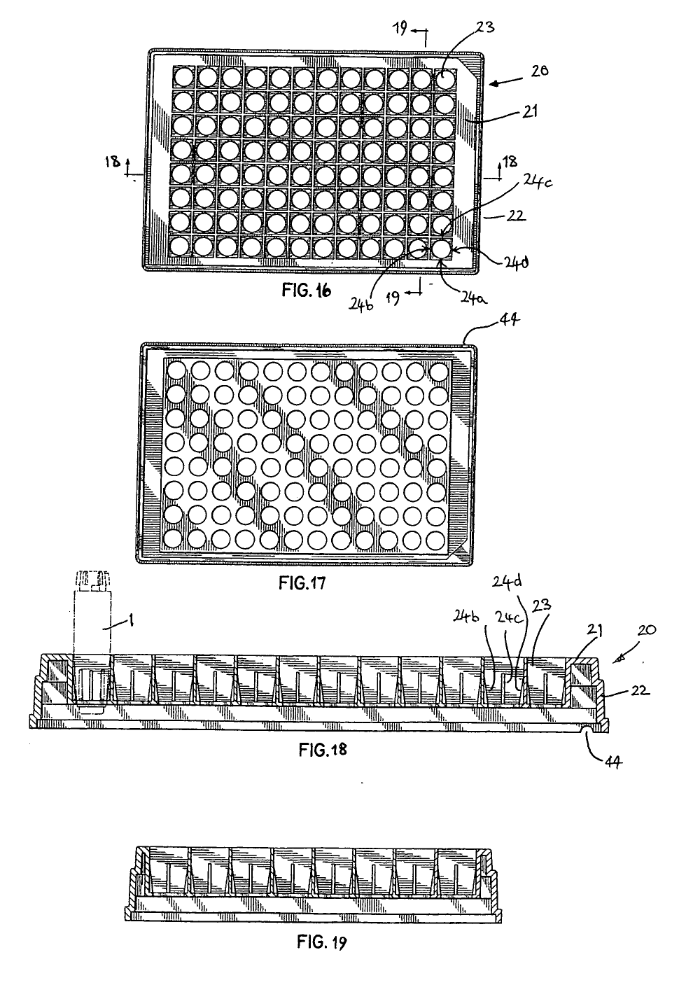

From the mouth end 3 to the opposing closed base end 5 of the tube 1, the bore of the tube 1 tapers inwardly in stages. An upper portion 4 of the tube 1 that incorporates the screw thread formation 2 is of substantially uniform internal diameter but below this screw threaded portion 4 the bore is instepped 1c or begins to taper inwardly. The external profile of the tube also tapers inwardly towards the base end 5 and is provided with an array of longitudinally extending ribs/splines 5a around its outer circumference proximate the base end 5 of the tube 1 for mounting of the tube 1 in a complementary aperture of a cluster tube rack (see FIG. 18).

Referring to FIGS. 5 to 10, the screw cap 6 is, like the tube, suitably a one-piece plastics moulding and is moulded with a screw thread formation 7 on a plug portion 8 of the cap 6 that is complementary to the screw thread formation 2 of the tube 1. However, the plastics material from which the cap 6 is moulded is, unlike the tube 1, not polypropylene but a thermoplastic elastomer (TPE), and in one preferred example is Santoprene™.

The cap 6 has a spined/ribbed head 9 with a plurality of radially outwardly projecting splines 19 for engagement by splines of a de-capping tool for turning the cap 6 to screw or unscrew it from the tube 1. Below the head 9 is a short rib-free neck portion 9a and below this an annular flange 10 that is broader than the diameter of the head 9 and that has a flat radially outer part on its underside which may butt against the upper surface 3b of the rim at the mouth 3 of the tube 1 (see FIG. 11) when the cap is fully screwed in place.

Below the flange 10, the cap transitions from head portion 9 to plug portion 8, with an uppermost part of the plug portion 8 comprising a frusto-conical tapering surface 11 that seats against the complementary frusto-conical surface/shoulder 3a of the rim of the opening at mouth end 3 of the tube 1 when the cap is screwed in place. Indeed, the seating of the frusto-conical tapering surface 11 of the plug against the complementary frusto-conical surface/shoulder 3a of the rim of the opening at mouth end 3 of the tube 1 forms an important gas-tight sealing interface between the cap 6 and the tube 1 at or just above the top of the threads and one which is enhanced in the final stages of screwing the cap 6 more tightly in place.

Immediately below the frusto-conical tapering surface 11, the plug portion 8 of the cap 6 incorporates the screw thread formation 7 of the cap 6 that co-operatively engages with the screw thread formation 2 of the tube 1 in use.

Below the cap's screw thread formation 7 the plug portion 8 of the cap 6 extends for a short distal length 12 of substantially constant diameter before transitioning to a terminal conical or frusto-conical end portion 13, the conical surface of which guides passage of the plug portion 8 of the cap 6 down the bore of the tube 1 even as the bore is/becomes narrower than the plug portion 8 of the cap 6 at 1c. From FIG. 11 inset drawing it will be seen that the transition 1c to a reduced diameter bore 1b is a concave or arcuate/radiused transition rather than a chamfered or frusto-conical transition, since this improves sealing efficiency and helps minimise the proportion of the tube 1 that needs to be dedicated to the parallel pressure seal feature discussed below.

Screw-tightening of the cap 6 into the tube 1 forces the short distal length 12 of the plug portion 8 of the cap 6 into a tight interference fit with the reduced diameter bore 1b of the tube 1 and provides a parallel pressure seal between the cap 6 and the tube 1. FIG. 4 and the enlarged detail view of FIG. 11 show the upper portion of the tube 1 having screw thread 2 as being of substantially greater internal diameter than the main bore 1b of the tube 1, the narrower main bore 1b facilitating the tight interference fit of the plug portion 8 of the cap 6 in the tube 1. The parallel pressure seal effectively seals the interface between the cap 6 and the tube 1 below the threads 2 whereby there is no risk of liquid tube contents travelling up the thread if the tube 1 is tilted or inverted.

Even without the use of any O-ring seals this arrangement provides two effective sealing zones, here shown as above and below the screw threaded region 2,7. Whether or not combined with the use of the thermoplastic elastomer to form the screw cap 6 this seal arrangement provides a very robust seal to the screw-capped cluster tube that withstands dramatic falls in temperature such as are involved when storing in a cryogenic environment. The use of thermoplastic elastomer in construction of the cap further enhances the seal. Indeed the seal may strengthen as the temperature falls. With this arrangement there is substantially no risk of the lid being forced off by gas expansion when subjected to the temperature changes associated with cryogenic storage in the gaseous phase above the liquid nitrogen of a liquid nitrogen cooled vessel.

Having discussed above the sealing characteristics of the screw capped tube, the adaptations of the tube and cap for ease of de-capping and re-capping will now be described further. This de-capping and re-capping is facilitated by provision of cluster tube racks adapted for this purpose and tools to facilitate de-capping and re-capping.

Referring to FIGS. 16 to 19, these show a cluster tube rack into which the cluster tubes of FIGS. 1 to 4 are mounted in an array of 8 rows×12 columns. The rack 20 has a broadly conventional form with an upper platform 21 and perimeter skirt 22 and with the receptacles/wells 23 to receive the tubes 1 extending downwardly from the platform 21 to a position substantially above the level of the bottom of the skirt 22. As can be most clearly seen in the inset in FIG. 18 and again in FIG. 19, each receptacle/well 23 is provided with an array of radially inwardly projecting splines 24a-24d with which the radially outwardly projecting splines 19 on the tubes 1 may co-operatively engage when the tube 1 is inserted into receptacle 23 in the rack 20 and turned. In the illustrated FIG. 1 embodiment of tube, there are eight radially outwardly projecting splines 5a provided on the frusto-conically tapered lower portion of each tube 1, being twice as many in number as the number of radially inwardly projecting splines 24a-d of the receptacles 23. The receptacles 23 are all generally square in plan and hence there are four main radial points at which the circular cylindrical tube 1 is close to the walls of the receptacle 23 and thus suitably four splines 24a-d in the receptacle 23. By having a greater number of splines 5a on the tube 1 this substantially reduces any turning required for any given tube to have spline meshing engagement with the splines 24a-d of its receptacle 23.

As can be further seen clearly from FIG. 18, the lowermost end of each tube 1 projects well beyond the lower extremity of the receptacle 23 whereby the bottom ends of the tubes 1 that carry machine-readable labels are exposed to be readily cleaned free of water and ice on removal from cryogenic storage and whereby the labels may be read by a label reading device positioned beneath the rack 20. A small cut-out 44 in the bottom of the skirt 22 of the rack 20 readily aids identification of the orientation of the rack 20 by the reading device.

The splines 24a-d of each receptacle 23 are tapered in the form of a buttress, being more prominent at their lowermost ends to follow the inwardly tapering profile of the lower ends of the tubes 1 and maintain contact with the splines 5a of the tube for their length. Co-operative engagement of the splines 5a on the tubes with the splines 24a-d on the receptacles 23 of the rack 20 ensures that each tube 1 is substantially held firm against rotation within the rack 20 and which facilitates de-capping and re-capping of the tubes in the rack 20.

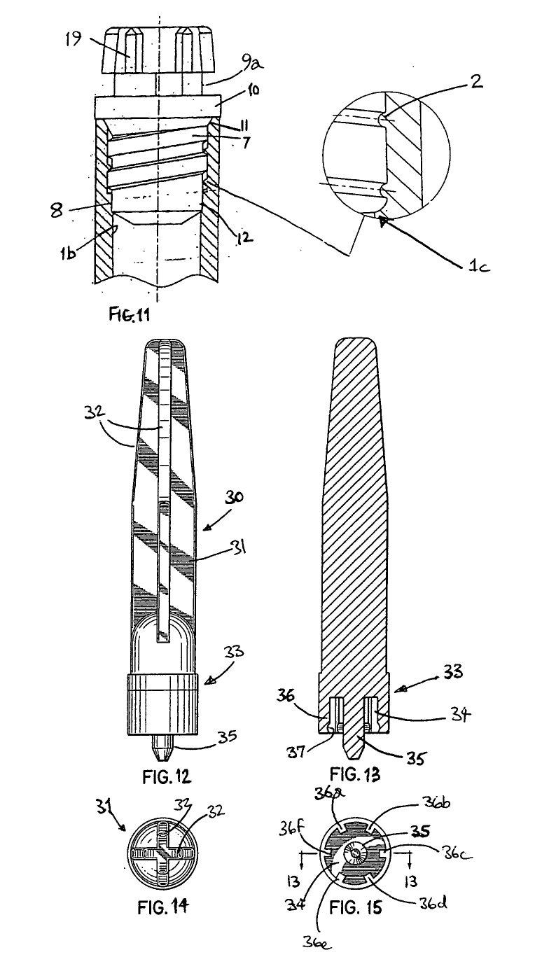

Referring to FIGS. 12 to 15, the manual de-capping tool 30 shown in those Figures is an elongate device having a handle body 31 with an array of four radially spaced apart large ribs 32 running along much of its length to facilitate grip by the user for turning of the tool 30. The working end of the tool 30 comprises a head 33 which is formed with a substantially circular cylindrical socket 34 in its front face and having a centring spigot 35 projecting forwardly and outwardly from the axial centre of the tool head 33. The centring spigot 35 is adapted to fit extending down into a central recess/bore 18 (FIGS. 7 and 8) in the upper side of the cap 1 that extends from the upper face of the cap 1 downwardly for much of the height of the cap 1. This recess 18 is a smooth-walled circular cylindrical recess that is free of splines. The socket 34 of the tool head 33 seats over the ribbed upper end of the cap 1.

A set of six radially inwardly projecting splines 36a-f provided on the head 33 within the socket 34 are adapted to co-operatively engage with the six splines 19 of the cap 1 when the tool 30 is turned about its longitudinal axis in the cap unscrewing direction.

The radially inwardly projecting splines 36 of the tool head 33 are of substantially uniform substantially rectangular cross section for much of their length but at their lowermost ends each is recessed with an arcuate recess/cut-out 37. Referring to FIGS. 5 to 10, it will be seen that in the cap 6, in the short substantially smooth circular cylindrical portion immediately beneath the splines 19, there are formed two arcuate bulges 38 whose arcuate form is of a complementary shape to the arcuate recesses 37 in the splines 36 of the head 33 of the manual de-capping tool.

The pair of radially outwardly extending protrusions/bulges 38 on the cap 6 just below the splines 19 are substantially radially opposite to each other and partially radially overlap or are slightly offset radially from the immediately adjacent splines 19. When the head 33 of the manual de-capping tool is passed down over the screw cap 6 and with the splines 36 of the tool's head 33 interdigitating with the splines 19 of the cap 6, the initial act of beginning to turn the tool about its axis will cause the splines 36 of the tool head 33 to engage with the bulges 38. The bulges 38 pass into the arcuate recesses/cut-outs 37 of the tool head splines 36 at the same time as the splines 36 of the tool head 33 are brought into pressing engagement with the splines 19 of the cap 6.

Continued turning of the tool transmits torque from the head 33 of the tool 30 to the cap 6 whereby the cap 6 is rotated. Since the tube 1 is held captive by its splines 5a being in meshing engagement with the splines 24a-d of the rack 20, the cap 6 is unscrewed by the tool 30. Continued unscrewing motion eventually leads to complete disengagement of the screw thread 7 on the cap 6 from the screw thread 2 within the tube 1 and enabling the cap 6 to be lifted free of the tube 1, with the cap 6 still attached to the tool head 33 of the tool 30 by the ongoing co-operative engagement of the bulges 38 on the cap 6 with the recesses 37 of the splines 36 on the tool head 33.

Once the operator is ready to re-apply the cap 6 to the tube 1 he need only lower the tool 30 with cap 6 still on the tool head 33 to bring the cap 6 back into engagement with the tube 1 and to rotate the tool 30 in the reverse direction to the unscrewing motion in order to re-screw the cap 6 back into place. Once the cap 6 has been screw tightened to its operative position providing the required tight seal between the cap 6 and tube 1, the tool head 33 is immediately able to be lifted free of engagement from the cap 6 since in that direction of rotation the splines 36 of the tool head 33 will have disengaged from the bulges 38 of the cap 6 as soon as the operator began to rotate the tool 30 in the screw threading direction.

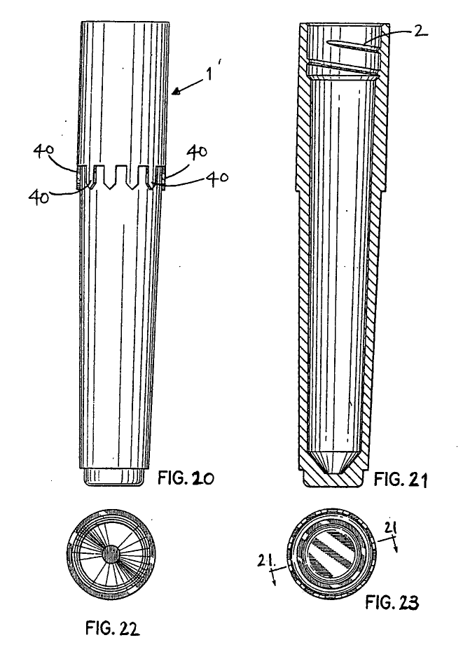

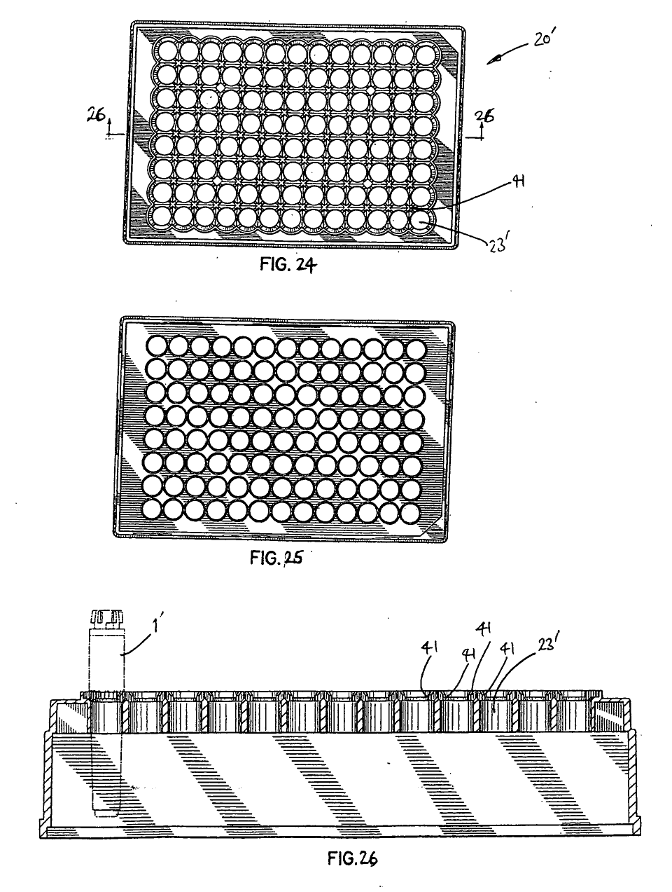

In a variant of the embodiment of tube and rack arrangement described above, referring to FIGS. 20 to 26, these show a higher capacity tube that suitably will hold a volume of at least about 1 ml and where, unlike the tube and rack arrangement described above, has the splines of the tube and rack located much higher up the tube, with the splines of the rack being substantially at the level of the platform of the rack rather than at the foot of the wells/recesses. In FIG. 20, it will be seen that the splines 40 on the tube 1′ are located on the tube 1′ outer circumferential surface at approximately two thirds of the way up the height of the tube. It will be further seen that they are many in number and suitably of the order of eight to twenty—being exemplified as twelve splines radially spaced apart around the circumference of the tube 1′. These splines 40 are effectively a continuation of the relatively broad outer circumference of the initial upper part of the exterior of the tube 1′ just above a point on the height of the tube 1′ where the external diameter is reduced, the lower two thirds of the tube 1′ being of a relatively lesser external diameter than the upper one third of the tube 1′.

The many small splines 40 facilitate swift co-operative engagement with splines 41 on the rack 20′. The splines 41 of the rack 20′ are formed extending upwardly from the upper surface/platform of the rack 20′, appearing as cross/cruciform formations at the intersections of the walls of the racks that define the receptacles/wells 23′. The relatively high number of splines 40 of this variant of tube 1′ greatly increases the probability that the tube 1′ will be in spline alignment with the splines 41 of the rack 20′ when the two are brought together and thus ensures that any adjustment needed in the rotation of the tube 1′ about its axis in order to seat properly is absolutely minimal.

As will be appreciated from the foregoing, the configuration of the apparatus of the present invention enables the operator to de-cap and re-cap a screw capped tube single handedly throughout the whole procedure, even including the final step of disengaging the cap from the tool head, and the adaptations for efficient sealing do away with the need for an O ring seal. These and other features and benefits of the present invention are apparent from the foregoing description. It will of course be appreciated that the embodiments described above and illustrated are examples and do not limit the spirit and scope of the invention.

1. A screw-capped tube for holding a liquid material therein, the tube having an open mouth at one end only which is adapted to be closed by the screw cap with an inner end of the screw cap extending into the open mouth of the tube, an opposing end of the cap to the inner end of the cap being provided with a circular cylindrical recess extending thereinto and whereof the cylindrical wall of the recess is free of splines, an outer circumferential surface of the cap being provided with a spline whereby the cap is adapted to co-operatively engage with a spline of a tool that will fit on to said opposite end of the cap for rotation of the cap by co-operative engagement of the spline of the tool with the spline of the cap.

2. A screw capped tube as claimed in claim 1 in combination with a said tool and whereof the tool has a head formed with a socket to mount over said opposing end of the cap and said at least one spline is formed in the socket of the head of the tool extending radially inwardly.

3. A screw capped tube as claimed in claim 2, wherein the socket of the head of the tool further comprises a centring spigot located substantially centrally of the socket and which is adapted to extend into the recess of the cap.

4. A screw capped tube as claimed in claim 2, wherein the tool head has a lifting co-operative engagement feature thereon to co-operatively engage with a complementary co-operative engagement feature on the cap whereby the cap may be held on the tool to be liftable by the tool when the tool head and cap are rotated in a first direction and which disengage, releasing the cap from the tool, when the tool is rotated in the opposing direction.

5. A screw capped tube as claimed in claim 4, wherein the lifting co-operative engagement feature of one of the cap and tool head is a prominence adjacent a spline of the cap or tool head and the other co-operative engagement feature is a recess in a spline of the other of the cap and tool head.

6. A screw-capped tube for holding a liquid material therein, the tube having an open mouth at one end only which is adapted to be closed by the screw cap with an inner end of the screw cap extending into the open mouth of the tube, the cap being provided with at least one spline whereby the cap is adapted to co-operatively engage with a spline of a tool that will fit on to said cap for rotation of the cap by co-operative engagement of the spline of the tool with the spline of the cap the tool head having a lifting co-operative engagement feature thereon to co-operatively engage with a complementary co-operative engagement feature on the cap whereby the cap may be held on the tool to be liftable with the tool when the tool head and cap are rotated in a first direction and which disengage, releasing the cap from the tool, when the tool is rotated in the opposing direction.

7. A screw-capped tube as claimed in claim 1 or 6 in combination with a rack for the tube wherein a well/receptacle in the rack to receive the tube has at least one spline to co-operatively engage with a complementary spline on the outer circumference of the tube.

8. A screw-capped tube in combination with a rack as claimed in claim 7, wherein the tube has a number of splines thereon for engagement with the splines of a receptacle of the rack, which is greater than the number of splines of the receptacle of the rack.

9. A screw-capped tube in combination with a rack as claimed in claim 8, wherein the splines of the rack are provided at or adjacent the upper surface/platform of the rack.

10. A screw-capped tube in combination with a rack as claimed in claim 9, wherein the splines of the rack comprise a cruciform formation that protrudes from the upper surface of the rack.

11. A screw-capped tube in combination with a rack as claimed in claim 7, wherein the splines of the tube are at a height position on the tube above where there is any substantial inward tapering or instep of the outside diameter of the tube.

12. A screw-capped tube in combination with a rack as claimed in claim 7, wherein the rack is provided with means for identifying the orientation of the rack from the underside of the rack to facilitate reading of identification codes on the bottom of tubes held in the rack by viewing the rack from the underside, the underside of the rack being otherwise substantially symmetrical, the means comprising a cut-out feature incorporated into the underside of the rack and visible from the underside and which is asymmetrically positioned on the underside of the rack.

13. A screw-capped tube as claimed in claim 1, wherein the screw cap has a plug portion that is adapted to extend into the bore of the tube and which has screw thread formations to engage with corresponding co-operatively engaging screw thread formations in the bore of the tube, the screw threaded part of the cap being formed of material having a different coefficient of thermal expansion than the corresponding co-operatively engaging screw threaded part of the tube.

14. A screw-capped tube as claimed in claim 1, wherein the screw cap has a plug portion that is adapted to extend into the bore of the tube and which has screw thread formations to engage with corresponding co-operatively engaging screw thread formations in the bore of the tube, wherein the plug portion has a tapering surface that seats against a complementary surface/shoulder at the mouth end of the tube to form a sealing interface between the cap and the tube at or above the top of the threads.

15. A screw-capped tube as claimed in claim 1, wherein the screw cap has a plug portion that is adapted to extend into the bore of the tube and which has screw thread formations to engage with corresponding co-operatively engaging screw thread formations in the bore of the tube, wherein below the cap's screw thread formation the plug portion of the cap extends for a distal length which forms a tight interference fit with the bore of the tube in use and provides a parallel pressure seal between the cap and the tube.

16. A screw-capped tube as claimed in claim 13, wherein the tube as a whole is formed of polypropylene and the cap bung portion or entirety of the cap is formed of an elastomeric material, suitably a thermoset elastomer or a thermoplastic elastomer such as, for example, Santoprene™.

17. A screw-capped tube as claimed in claim 13, wherein the cap portion that co-operatively engages with the tube has a part that forms an interference fit in the bore of the tube, whereby the interference at the interference fit portion will increase when the capped tube is refrigerated.

18. A screw-capped tube as claimed in claim 13, wherein the capped tube has no O-ring seal components provided therein to seal between the cap and the tube.

19. A screw-capped tube for holding a liquid material therein, the tube having an open mouth at one end only and which is adapted to be closed by the screw cap, wherein at least a part of the cap that engages with the tube is formed of a material that is different from the co-operative engaging part of the tube whereby when the capped tube is subjected to a significantly colder thermal environment the tightness of fit between the cap and the tube is maintained or increased.

20. A screw-capped tube for holding a liquid material therein, the tube having an open mouth at one end only and which is adapted to be closed by the screw cap, the screw cap having a plug portion that is adapted to extend into the bore of the tube and which has screw thread formations to engage with corresponding co-operatively engaging screw thread formations in the bore of the tube, the plug portion having a tapering surface that seats against a complementary surface/shoulder at the mouth end of the tube to form a sealing interface between the cap and the tube at or above the top of the threads.

21. A screw-capped tube as claimed in claim 20, wherein the capped tube has no O-ring seal components provided therein to seal between the cap and the tube.

22. A screw-capped tube for holding a liquid material therein, the tube having an open mouth at one end only and which is adapted to be closed by the screw cap, the screw cap having a plug portion that is adapted to extend into the bore of the tube and which has screw thread formations to engage with corresponding co-operatively engaging screw thread formations in the bore of the tube, wherein below the cap's screw thread formation the plug portion of the cap extends for a distal length which forms a tight interference fit with the bore of the tube in use sealing between the cap and the tube.

23. A screw-capped tube as claimed in claim 22, wherein the capped tube has no O-ring seal components provided therein to seal between the cap and the tube.

24. A screw-capped tube as claimed in claim 7, wherein the screw cap has a plug portion that is adapted to extend into the bore of the tube and which has screw thread formations to engage with corresponding co-operatively engaging screw thread formations in the bore of the tube, the screw threaded part of the cap being formed of material having a different coefficient of thermal expansion than the corresponding co-operatively engaging screw threaded part of the tube.

25. A screw-capped tube as claimed in claim 7, wherein the screw cap has a plug portion that is adapted to extend into the bore of the tube and which has screw thread formations to engage with corresponding co-operatively engaging screw thread formations in the bore of the tube, wherein the plug portion has a tapering surface that seats against a complementary surface/shoulder at the mouth end of the tube to form a sealing interface between the cap and the tube at or above the top of the threads.

26. A screw-capped tube as claimed in claim 7, wherein the screw cap has a plug portion that is adapted to extend into the bore of the tube and which has screw thread formations to engage with corresponding co-operatively engaging screw thread formations in the bore of the tube, wherein below the cap's screw thread formation the plug portion of the cap extends for a distal length which forms a tight interference fit with the bore of the tube in use and provides a parallel pressure seal between the cap and the tube.

27. A screw-capped tube as claimed in claim 24, wherein the tube as a whole is formed of polypropylene and the cap bung portion or entirety of the cap is formed of an elastomeric material, suitably a thermoset elastomer or a thermoplastic elastomer such as, for example, Santoprene™.

28. A screw-capped tube as claimed in claim 24, wherein the cap portion that co-operatively engages with the tube has a part that forms an interference fit in the bore of the tube, whereby the interference at the interference fit portion will increase when the capped tube is refrigerated.

29. A screw-capped tube as claimed in claim 24, wherein the capped tube has no O-ring seal components provided therein to seal between the cap and the tube.
